(19) United States
(12) Patent Application Publication
(10) Pub. No.: US 2024/0244536 A1
(43) Pub. Date: Jul. 18, 2024

(54) POWER CONTROL AND INDICATION FOR WIRELESS COMMUNICATIONS

(71) Applicant: ZTE Corporation, Shenzhen (CN)

(72) Inventors: Shuaihua KOU, Shenzhen (CN); Wei GOU, Shenzhen (CN); Xingguang WEI, Shenzhen (CN); Jing SHI, Shenzhen (CN); Xianghui HAN

(73) Assignee: ZTE Corporation, Shenzhen, GD (CN)

(21) Appl. No.: 18/622,024

(22) Filed: Mar. 29, 2024

Related U.S. Application Data
(63) Continuation of application No. PCT/CN2022/090040, filed on Apr. 28, 2022.

(51) Int. Cl. H04W 52/34; H04W 52/14

(52) U.S. Cl. CPC H04W 52/34; H04W 52/143

(57) ABSTRACT

This document generally relates to wireless communication involving transmission power. Some embodiments include at least one communication node that determines a downlink or uplink transmission power based on at least one power control parameter, wherein each of a plurality of power control parameters corresponds to a respective one of a plurality of resource types; and communicates (transmits and/or receives) a downlink or uplink signal or channel according to the transmission power. In addition or alternatively, a wireless access node generates a downlink control information (DCI) or a medium access control (MAC) control element (CE) to indicate downlink transmission powers, and transmits the DCI or MAC CE to a user device, which receives the DCI or MAC CE and determines the downlink transmission powers.

### CROSS-REFERENCE TO RELATED APPLICATIONS

This application is a continuation of International Patent Application No. PCT/CN2022/090040, filed Apr. 28, 2022. The contents of International Patent Application No. PCT/CN2022/090040 are incorporated herein by reference in their entirety.

### TECHNICAL FIELD

This document is directed generally to wireless communication that involves power control and indication.

### BACKGROUND

In time division duplex (TDD) systems, a slot may be used only for downlink transmission or only for uplink transmission at a time. Correspondingly, downlink slots can only be used for downlink transmissions, and uplink slots can only be used for uplink transmissions. In contrast, when full duplexing is used, a slot can be used for both a downlink transmission and an uplink transmission. In general, the downlink transmission and the uplink transmission may be allocated different frequency resources. Ways to improve power control for better performance in such systems may be desirable.

### SUMMARY

This document relates to methods, systems, apparatuses and devices for wireless communication. In some implementations, a method for wireless communication includes: determining, with a wireless access node, a downlink transmission power based on at least one downlink power control parameter of a plurality of downlink power control parameters, wherein each of the plurality of downlink power control parameters corresponds to a respective one of a plurality of resource types; and transmitting, with the wireless access node, a downlink signal or a downlink channel to a user device according to the downlink transmission power.

In some other implementations, a method for wireless communication includes: determining, with a user device, a downlink transmission power based on at least one downlink power control parameter of a plurality of downlink power control parameters, wherein each of the plurality of downlink power control parameters corresponds to a respective one of a plurality of resource types; and receiving, with the user device, a downlink signal or a downlink channel from a wireless access node, the downlink signal or the downlink channel transmitted according to the downlink transmission power.

In some other implementations, a method for wireless communication includes: generating, with a wireless access node, a downlink control information (DCI) or a medium access control (MAC) control element (CE) to indicate a plurality of downlink transmission powers for transmission of a downlink signal or a downlink channel, wherein each of the plurality of downlink transmission powers corresponds to a respective one of a plurality of time units in which the downlink signal or the downlink channel is to be transmitted; and transmitting, with the wireless access node, the DCI or the MAC CE to a user device.

In some other implementations, a method for wireless communication includes: receiving, with a user device, a downlink control information (DCI) or a medium access control (MAC) control element (CE); and determining, with the user device, a plurality of downlink transmission powers for transmission of a downlink signal or a downlink channel from the DCI or the MAC CE, wherein each of the plurality of downlink transmission powers corresponds to a respective one of a plurality of time units in which the downlink signal or the downlink channel is transmitted.

In some other implementations, a method for wireless communication includes: determining, with a user device, an uplink transmission power based on at least one uplink power control parameter of a plurality of uplink power control parameters, wherein each of the plurality of uplink power control parameters corresponds to a respective one of a plurality of resource types; and transmitting, with the user device, an uplink signal or an uplink channel to a wireless access node according to the uplink transmission power.

In some other implementations, a method for wireless communication includes: determining, with a wireless access node, an uplink transmission power based on at least one uplink power control parameter of a plurality of uplink power control parameters, wherein each of the plurality of uplink power control parameters corresponds to a respective one of a plurality of resource types; and receiving, with the wireless access node, an uplink signal or an uplink channel from a user device, the uplink signal or the uplink channel transmitted according to the uplink transmission power.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a diagram of an example slot format.

FIG. 3 shows a diagram of an example resource configuration, illustrating different resource types.

FIG. 4A shows a flow chart of an example method for wireless communication that involves downlink transmission power.

FIG. 4B shows a flow chart of a second example method for wireless communication that involves downlink transmission power.

FIG. 5A shows a flow chart of a third example method for wireless communication that involves downlink transmission power.

FIG. 5B shows a flow chart of a fourth example method for wireless communication that involves downlink transmission power.

FIG. 6 shows a diagram of an example DL signal transmission power indication for a plurality of slots.

FIG. 7 shows a diagram of another example DL signal transmission power indication for a plurality of slots.

FIG. 8A shows a flow chart of an example method for wireless communication that involves uplink transmission power.

FIG. 8B shows a flow chart of another example method for wireless communication that involves uplink transmission power.

FIG. 9 shows a flow chart of an example method for wireless communication that involves measurement results for reference signals.

### DETAILED DESCRIPTION

The present description describes various embodiments of systems, apparatuses, devices, and methods for wireless communications involving determining transmission power.

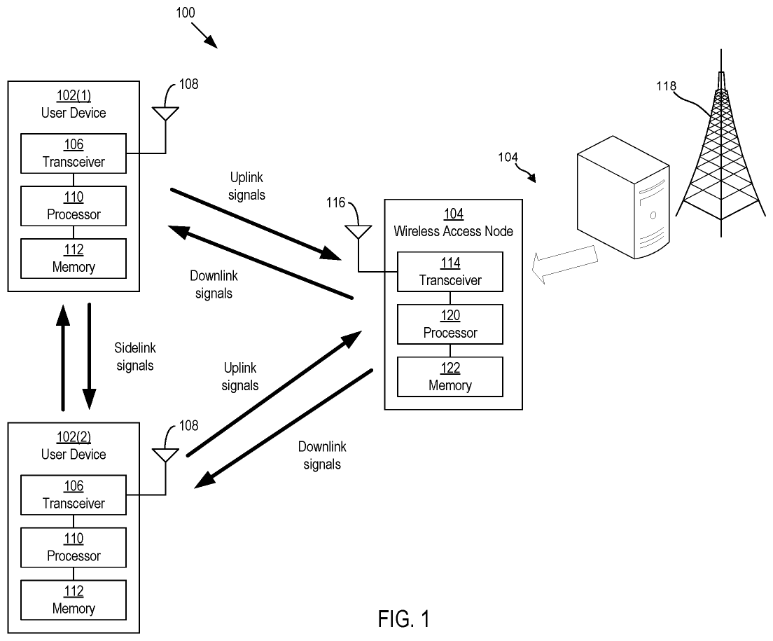

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IOT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may in also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots or frames can be configured by the wireless access node 104 or specified by a protocol. In particular examples, a slot can be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

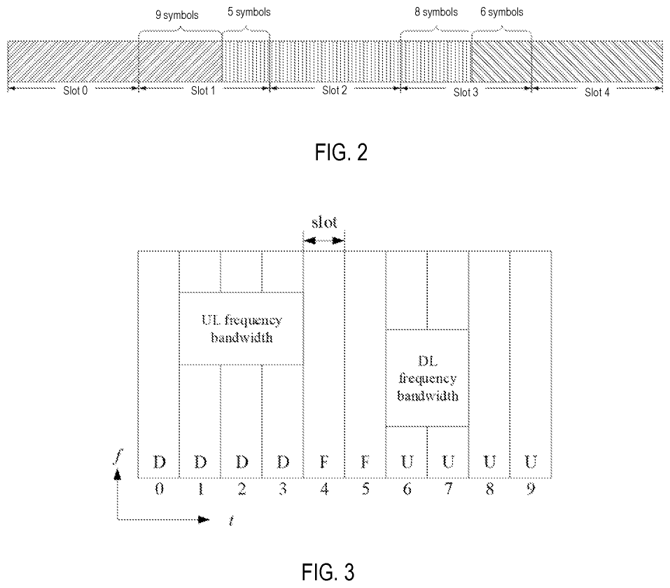

FIG. 2 is a diagram of an example slot format. In FIG. 2, for example, five slots are shown, denoted by Slot 0, Slot 1, Slot 2, Slot 3, and Slot 4. The symbols of Slot 0 and the first nine symbols in Slot 1 are configured as downlink symbols. Accordingly, a downlink (DL) bandwidth part (BWP) includes these symbols/slots. Also, the last five symbols in the Slot 1, the symbols of Slot 2, and the first eight symbols in Slot 3 are configured as flexible symbols (i.e., they are used as uplink or downlink transmission symbols). Additionally, the last six symbols in Slot 3 and the symbols in Slot 4 are configured as uplink symbols. Accordingly, an uplink (UP) BWP includes these symbols/slots.

Additionally, in the wireless communication system 100, the wireless access node 104 may configure a downlink (DL) bandwidth part (BWP) to include a frequency resource for a downlink transmission, and/or an uplink (UL) BWP to include a frequency resource for an uplink transmission for a user device 102. Also, in various embodiments, the wireless access node 104 may configure or determine a slot as a downlink slot, an uplink slot, or a flexible slot. Similarly, the wireless access node 104 may configure or determine a symbol as a downlink symbol, an uplink symbol, or a flexible symbol.

In some embodiments, in a downlink slot or symbol or in a flexible slot or symbol, a first frequency bandwidth (or frequency resource) may be configured for an uplink transmission for a user device 102. In various of these embodiments, the first frequency bandwidth may be completely or partly within, or completely or partly outside of the DL BWP. For such embodiments, in the downlink slot or symbol or in the flexible slot or symbol, a first part of the frequency resources may be used for downlink transmissions and a second part of the frequency resources may be used for uplink transmissions.

As described herein, resources, including time domain resources and frequency domain resources, used for transmissions may be characterized or determined as, or be defined as having resource types. That is, a given resource, including a given time domain resource or a given frequency domain resource, may have a corresponding one of a plurality of resource types. In various of these embodiments, a resource used for a downlink transmission may be referred to as a downlink resource, and may have a corresponding downlink resource type of a plurality of different downlink resources types, and/or a resource used for uplink transmissions may be referred to as an uplink resource, and may have a corresponding uplink resource type of a plurality of different uplink resource types.

Further, as used herein, a time unit (e.g., a slot or a symbol) has a first downlink resource type if it is configured as a downlink time unit, and all frequency resources in a bandwidth part for, in, or corresponding to the time unit are used for downlink transmissions. Additionally, a frequency resource (e.g., bandwidth) has a first downlink resource type if it is used for downlink transmissions, and is for, in, or corresponds to a time unit having the first downlink resource type.

Additionally, a time unit has a second downlink resource type if it is configured as a downlink time unit, and a bandwidth part for, in, or corresponding to the time unit has a first part used for downlink transmissions and a second part used for uplink transmissions. A frequency resource (e.g., bandwidth) has a second downlink resource type if it is used for downlink transmissions, and is for, in, or corresponds to a time unit having the second downlink resource type.

Also, a time unit has a third downlink resource type if it is configured as an uplink time resource, and a bandwidth part for, in, or corresponding to the time resource has a first part used for uplink transmissions and a second part used for downlink transmissions. A frequency resource (e.g., bandwidth) has a third downlink resource type if it is used for downlink transmissions, and is for, in, or corresponds to a time unit having the third downlink resource type.

Similarly, in an uplink slot or symbol, or in a flexible slot or symbol, a second frequency bandwidth (or frequency resource) may be configured for a downlink transmission. In various of these embodiments, the second frequency bandwidth may be completely or partly within, or completely or partly outside of, the UL BWP. For such embodiments, in the uplink slot or symbol or in the flexible slot or symbol, a first part of the frequency resources may be used for downlink transmissions and a second part of the frequency resources may be used for uplink transmissions.

As used herein, a time unit (e.g., a slot, a symbol, a frame, a sub-frame, or a sub-slot) has a first uplink resource type if it is configured as an uplink time unit, and all frequency resources in a bandwidth part for, in, or corresponding to the time unit are used for uplink transmissions. A frequency resource (e.g., bandwidth) has a first uplink resource type if it is used for uplink transmissions, and is for, in, or corresponds to a time unit having the first uplink resource type.

Additionally, a time unit has a second uplink resource type if it is configured as an uplink time unit, and a bandwidth part for, in, or corresponding to the time unit has a first part used for uplink transmissions and a second part used for downlink transmissions. A frequency resource (e.g., bandwidth) has a second uplink resource type if it is used for uplink transmissions, and is for, in, or corresponds to a time unit having the second uplink resource type.

Also, a time unit has a third uplink resource type if is configured as a downlink time resource, and a bandwidth part for, in, or corresponding to the time resource has a first part used for downlink transmissions and a second part used for uplink transmissions. A frequency resource (e.g., bandwidth) has a third uplink resource type if it is used for uplink transmissions, and is for, in, or corresponds to a time unit having the third uplink resource type.

FIG. 3 shows a diagram of an example resource configuration, illustrating different resource types. As shown in FIG. 3, the example configuration includes 10 slots denoted by Slots 0-9. The first 4 slots (Slot 0 to Slot 3) are each configured as a DL slot; Slot 4 and Slot 5 are each configured as a flexible slot; and the last 4 slots (Slot 6 to Slot 9) are each configured as an UL slot.

Further, in the example resource configuration in FIG. 3, all of the frequency resources of the BWP for Slot 0 is used for downlink transmissions. That is, the BWP for Slot 0 does not have any frequency resources (bandwidth) used for uplink transmissions. Accordingly, Slot 0 has the first downlink resource type. Also, any frequency resource (bandwidth) for, in, or corresponding to Slot 0 has the first downlink resource type.

Additionally, an UL frequency resource (bandwidth) is configured for UL transmissions in each of Slot 1, Slot 2, and Slot 3. As such, Slot 1, Slot 2, and Slot 3 each have the second downlink resource type (from the DL transmission perspective) and each have the third uplink resource type (from the UL transmission perspective) since they are each configured as downlink time slots, and their corresponding BWPs each have a first part used for downlink transmissions and a second part used for uplink transmissions. Additionally, in each of Slot 1, Slot 2, and Slot 3, the frequency resource used for downlink transmissions has the second downlink resource type since it is in a time slot having the second downlink resource type, and the frequency resource used for uplink transmissions has the third uplink resource type since it is in a time slot having the third uplink resource type.

Additionally, a DL frequency resource (bandwidth) is configured for DL transmissions in each of Slot 6 and Slot 7. As such, Slot 6 and Slot 7 each have the third downlink resource type (from the DL transmission perspective) and each have the second uplink resource type (from the UL transmission perspective) since they are each configured as uplink time slots, and their corresponding BWPs each have a first part used for downlink transmissions and a second part used for uplink transmissions. Additionally, the frequency resource used for uplink transmissions has the second uplink resource type since it is in a time slot having the second uplink resource type, and the frequency resource used for downlink transmissions has the third downlink resource type since it is in a time slot having the third downlink resource type.

Additionally, each of Slot 8 and Slot 9 does not have a DL frequency bandwidth configured for DL transmission. That is, all of the frequency resources in Slot 8 and Slot 9 are used for UL transmissions. As such, each of Slot 8 and Slot 9 have the first uplink resource type, and correspondingly, frequency resources in Slot 8 and Slot 9 have the first uplink resource type.

Also, although not shown in FIG. 3, in other embodiments, there may be a frequency gap between a downlink frequency resource and an uplink frequency resource in a given slot. Such a frequency gap may not be used for DL transmissions or UL transmissions.

Additionally, in some embodiments, for transmission of a signal or channel, the transmission power may be indicated by a way of an absolute power indication or a relative power indication. For the absolute power indication, the wireless access node 104 may directly indicate the transmission power of the signal. For example, the wireless access node 104 may configure the transmission power of the signal to be a power value, such as 12 decibel milliwatt (dBm), for example. Also, for the relative power indication, a power offset relative to the transmission power of a second signal is indicated for a first signal. For such relative power indication, a communication node, such as a user device 102, may determine the transmission power of a first signal based on a power offset and a transmission power of a second signal. To illustrate, suppose the wireless access node 104 configures a power offset for a second signal (e.g., a channel state information reference signal (CSI-RS)) to be 3 dB relative to the transmission power of a first signal, such as a synchronization signal/physical broadcast channel block (SSB). In turn, the user device 102 may determine that the transmission power of the second signal (e.g., the CSI-RS) is 15 dBm (i.e., 12 dBm+3 dB).

In addition or alternatively, the transmission power may be indicated by a way of implicit indication. For such embodiments, the transmission power may be determined (or calculated) based on one or more other parameters, e.g., the bandwidth of the signal, a bandwidth part (BWP), or an allocated resource, as non-limiting examples. The wireless access node 104 may configure one or more parameters or parameter values, wherein each correspond to a respective one or more transmission power values. In addition or alternatively, a communication node, such as a user device 102, may be configured to determine or derive a transmission power value based on a determined one or more parameter values. For example, a communication node may determine a transmission power of a signal with a second transmission bandwidth based on a configured transmission power and the second transmission bandwidth. To illustrate for example, the wireless access node 104 may configure a transmission power to be P watts (W) or P dBm. Further, suppose a first transmission bandwidth is N physical resource blocks (PRBs) or N resource elements (REs), and a second transmission bandwidth of the signal is M PRBs or M REs. In turn, a communication node may determine a transmission power for the signal based on the configured transmission power P, the first transmission bandwidth N, and the second transmission bandwidth M. For example, the communication node may determine or calculate the transmission power according to or using an algorithm or mathematical formula. Example mathematical formulates may include:

$$\\ P * ( N / M ) W or P + 10 * {log}_{10} ( N / M ) dBm .$$

In addition, in various embodiments using implicit indication, one or more of the parameters used to indicate transmission power may depend on a resource type associated with the one or more parameters. For example, the second transmission bandwidth in the above example may depend on an uplink resource type or a downlink resource type for a time unit and/or a frequency resource. In particular, the second transmission bandwidth may be within a configured frequency resource or in a slot or symbol having a particular one of the resource types.

As example illustration with reference to FIG. 3, suppose the wireless access node 104 configures the bandwidth for the first DL resource type, the second DL resource type, and the third DL resource type to be 100 PRB, 50 PRB and 25 PRB, respectively. In addition, suppose the wireless access node 104 configures a transmission power corresponding to the first DL resource type to be 15 dBm. Suppose further that the wireless access node 104 is to transmit a CSI-RS in Slot 0. The user device 102 may determine that Slot 0 has the first DL resource type, and in turn, determine that the transmission bandwidth for transmission of the CSI-RS in Slot 0 is 100 PRB. In turn, the user device 102 may determine that the transmission power for transmission of the CSI-RS in Slot 0 is 15 dBm. In addition or alternatively, suppose that the wireless access node 104 is to transmit the CSI-RS in downlink Slot 1, Slot 2, or Slot 3. The user device 102 may determine that Slots 1, 2, or 3 has the second DL resource type, and in turn, determine that the transmission bandwidth for transmission of the CSI-RS in Slots 1, 2, or 3 is 50 PRB. In turn, the user device 102 may determine that the transmission power for the transmission of the CSI-RS in Slots 1, 2, or 3 based on the transmission power for the first DL resource type, the bandwidth for the first DL resource type, and the bandwidth for the second DL resource type. In addition, the user device 102 may determine the transmission power according to an algorithm or mathematical formula, such as described above. For example, the user device 102 may determine the transmission power for transmission of the CSI-RS in Slots 1, 2, or 3 to be 18 dBm (15+10*log 10(100/50) dBm). In addition or alternatively, suppose that the wireless access node 104 is to transmit the CSI-RS in uplink Slot 6 or Slot 7. In turn, the user device 102 may determine that Slots 6 or 7 has the third DL resource type, and in turn, determine that the transmission bandwidth for transmission of the CSI-RS in Slots 6 or 7 is 25 PRB. In turn, the user device may determine that the transmission power for the transmission of the CSI-RS in Slot 6 or Slot 7 based on the transmission power for the first DL resource type, the bandwidth for the first DL resource type, and the bandwidth for the third DL resource type. In addition, the user device 102 may determine the transmission power according to an algorithm or mathematical formula, such as described above. For example, the user device 102 may determine the transmission power for transmission of the CSI-RS in Slot 6 or 7 to be 21 dBm (15+10*log 10(100/25) dBm).

In addition or alternatively, the wireless access node 104 may configure or indicate the second transmission bandwidth via a DCI, a medium access control (MAC) control element (CE), or radio resource control (RRC) signaling. For example, the DCI indicates that the bandwidth of the CSI-RS transmitted in Slot 4 is 75 PRBs. In turn, the user device 102 determines the bandwidth of 75 PRBs indicated by the DCI, and in turn determines that the transmission power for transmission in Slot 4 based on the transmission power for the first DL resource type, the bandwidth for the first DL resource type, and the bandwidth indicated by the DCI. In addition, the user device 102 may determine the transmission power according to an algorithm or mathematical formula, such as describe above. For example, the user device 102 may determine the transmission power for transmission on Slot 4 to be 16.2 dBm (15+10*log 10(100/75) dBm).

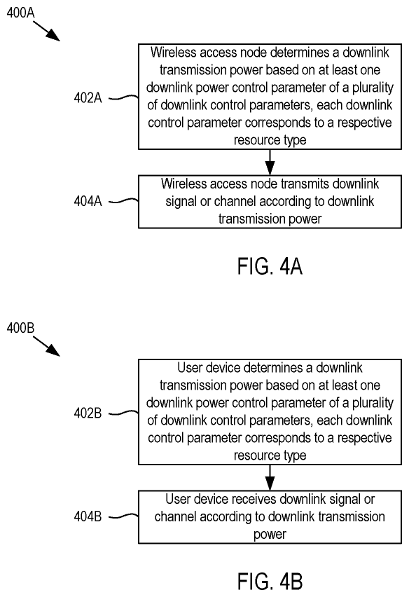

FIG. 4A shows a flow chart of an example method 400 for wireless communication that involves downlink transmission power. At block 402A, the wireless access node 104 may determine a downlink transmission power based on at least one downlink power control parameter of a plurality of downlink power control parameter. Each of the plurality of downlink power control parameters may correspond to a respective one of a plurality of resource types. In any of various embodiments, the each of the plurality of resource types may include a DL resource type or an UL resource type, such as the first, second, or third DL resource types, or the first, second, or third UL resource types, such as described above. At block 404A, the wireless access node 104 may transmit a downlink signal or a downlink channel to a user device 102 according to the downlink transmission power determined at block 402A. In various embodiments, the downlink signal may include a synchronization signal/physical broadcast channel block (SSB), a channel state information reference signal (CSI-RS), a remote interference management reference signal (RIM-RS), or a positioning reference signal (PRS). In addition or alternatively, the physical channel may include a PDSCH, physical broadcast channel (PBCH), or a PDCCH.

FIG. 4B shows a flow chart of an example method 400B for wireless communication that involves downlink transmission power. At block 402B, user device 102 may determine a downlink transmission power based on at least one downlink power control parameter of a plurality of downlink power control parameter. Each of the plurality of downlink power control parameters may correspond to a respective one of a plurality of resource types. In any of various embodiments, the each of the plurality of resource types may include a DL resource type or an UL resource type, such as the first, second, or third DL resource types, or the first, second, or third UL resource types, such as described above. At block 404B, the user device 102 may receive a downlink signal or a downlink channel from a wireless communication node 104 according to the downlink transmission power determined at block 402B. In various embodiments, the downlink signal may include a synchronization signal/physical broadcast channel block (SSB), a channel state information reference signal (CSI-RS), a remote interference management reference signal (RIM-RS), or a positioning reference signal (PRS). In addition or alternatively, the physical channel may include a PDSCH, physical broadcast channel (PBCH), or a PDCCH.

Other embodiments are possible including those the combine two or more of the blocks from methods 400A and 400B.

In further detail, for at least some embodiments, including some corresponding to FIGS. 4A and/or 4B, the wireless access node 104 may configure a plurality of power control parameters for transmission of a downlink channel or downlink signal. One of the plurality of power control parameters may indicate a transmission power to be used for transmission of a DL signal or a DL channel. In particular, the one of the plurality of power control parameters may correspond to a particular resource type that a resource in which the DL signal or channel is transmitted has. For example, a first power control parameter may indicate a transmission power of a downlink signal or channel transmitted on a resource having the first downlink resource type; a second power control parameter may indicate a transmission power of a downlink signal or channel transmitted on a resource having the second DL resource type; and a third power control parameter may indicate a transmission power of a downlink signal or channel transmitted on the third DL resource (or the third DL slot/symbol). In addition, in various embodiments, the first power control parameter may indicate the transmission power of the downlink signal or channel irrespective of whether the downlink signal or channel is transmitted on a resource having the first downlink resource type or the second downlink resource type if the downlink signal or channel is a group common signal. For example, a SSB, a PDSCH carrying paging information or system information, a PDCCH carrying group common information, or a PDCCH scheduling paging information or system information. In addition, in any of various embodiments, each of the plurality of power control parameters may be configured via absolute power indication, relative power indication, and/or implicit indication, as previously described.

In accordance with the above, at least one communication node, such as the wireless access node 104 and/or a user device 102 to which the wireless access node 104 is to transmit a downlink signal, may determine to communicate a downlink signal. The at least one communication node may determine a resource on which to transmit the downlink signal, a resource type of a plurality of resource types for the resource, and a power control parameter of the plurality of power control parameters that corresponds to the determined resource type. In turn, the at least one communication node may determine the downlink transmission power that corresponds to the determined power control parameters.

As an example illustration for absolute power indication, suppose three power control parameters are configured for a downlink signal, such as a SSB. A first power control parameter may indicate that the SSB transmission power is 10 dBm when the SSB is transmitted on a resource having the first DL resource type (e.g., Slot 0 in FIG. 3). A second power control parameter may indicate that the SSB transmission power is 15 dBm when the SSB is transmitted on a resource having the second DL resource type (e.g., Slot 1, Slot 2, or Slot 3 in FIG. 3). The third power control parameter may indicate that the SSB transmission power is 8 dBm when the SSB is transmitted on a resource having the third DL resource type (e.g., Slot 6 or Slot 7 in FIG. 3). Correspondingly, upon determining the DL resource type for a given resource, the wireless access node 104 and/or the user device 102 may determine a downlink transmission power for transmission of the downlink signal on that given resource. For example, if the wireless access node 104 and/or the user device 102 determines to communicate a downlink signal in Slot 0, the wireless access node 104 and/or the user device 102 may determine that Slot 0 has a first DL resource type, and in turn, determine that the downlink transmission power to transmit in Slot 0 is 10 dBm.

In addition or alternatively, for relative power indication, a power offset may be indicated by a power control parameter, where the power offset indicates a power change relative to a transmission power indicated by another power control parameter. For illustrate, a first power control parameter may indicate that a CSI-RS transmission power is 12 dBm when the CSI-RS is transmitted on a slot having the first DL resource type (e.g., Slot 0). In addition, a second power control parameter may indicate a power offset value of 3 dB. The second power control parameter may also indicate that the power offset value is relative to the transmission power of the CSI-RS transmitted on a resource having the first DL resource type. So, for example, suppose the CSI-RS is to be transmitted in a slot having the second DL resource type (e.g., Slot 1, 2, or 3). The at least one communication node, including the wireless access node 104 and/or the user device 102, may determine the downlink transmission power for the transmission of the downlink signal or channel in the slot having the second DL resource type based on the first power control parameter and the second power control parameter. For example, the at least one communication node may determine that the downlink transmission power is 15 dBm (12 dBm+3 dB).

In addition or alternatively, for implicit power indication, a second power control parameter may indicate a transmission bandwidth for transmission of a DL signal or channel on a second DL resource. The at least one communication node, for example, the user device 104 and/or the user device 102, may determine the transmission power of the DL signal or channel transmitted on a resource having the second DL resource type based on at least the indicated transmission bandwidth, and a transmission power indicated by another power control parameter.

In addition or alternatively, in some embodiments, the power control parameters may include a ratio of PDSCH energy per resource element (EPRE) to the PDSCH demodulation reference signal (DMRS) EPRE. In various of these embodiments, the wireless access node 104 may configure a plurality of ratios for a user device 102. A first ratio of the plurality of ratios may be used for a PDSCH transmitted on a resource having the first DL resource type; a second ratio of the plurality of ratios may be used for a PDSCH transmitted on a resource having the second DL resource type; and a third ratio of the plurality of ratios may be used for a PDSCH transmitted on a resource having the third DL resource type.

In addition or alternatively, in some embodiments, one of the plurality of power control parameters may indicate a transmission power of DL signal channel or signal transmitted on multiple resources having multiple resource types. For example, a second power control parameter may indicate a downlink transmission power for transmission of a downlink signal or channel transmitted on a second resource having the second DL resource type and a third resource having the third DL resource type.

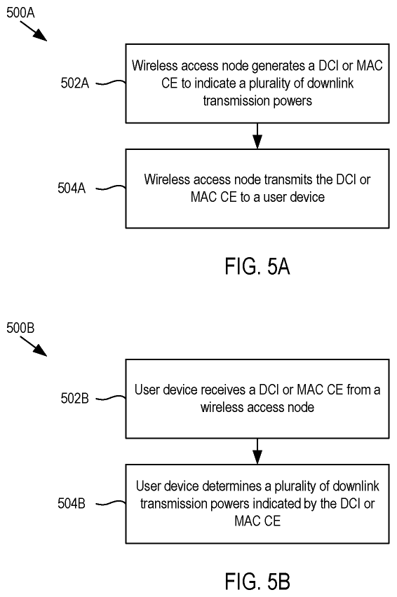

FIG. 5A shows a flow chart of an example method 500A for wireless communication that involves downlink transmission power. At block 502A, a wireless access node 104 may determine a plurality of downlink transmission powers for transmission of a downlink signal or a downlink channel to indicate in a downlink control information (DCI) or a medium access control (MAC) control element (CE), and/or the wireless access node 104 may generate a DCI or MAC CE to indicate the plurality of downlink transmission powers. Each of the plurality of transmission powers corresponds to a respective one of a plurality of time units in which the downlink signal or channel is transmitted. Each time unit of the plurality of time units may be a symbol (e.g., an orthogonal frequency division multiplexing (OFDM) symbol), a sub-slot, a slot, a sub-frame, or a system frame. In addition or alternatively, the DCI may have a DCI format, and the DCI format may be in a common search space or a UE-specific search space.

At block 504A, the wireless access node 104 may transmit the DCI or the MAC CE to a user device 102 that is to receive the downlink signal or channel. Also, for at least some embodiments, at block 504A, the wireless access node 104 may transmit the downlink signal or channel to the user device 102 after or concurrent with transmitting the DCI or the MAC CE to the user device 102. The DCI or MAC CE may indicate the plurality of downlink transmission powers that the wireless access node 104 determines and/or indicates in the DCI or MAC CE at block 502A. This way, through transmission of the DCI or MAC CE, the user device 102 may know or determine the downlink transmission powers for the plurality of time units in order to properly or successfully receive the downlink signal or channel from the wireless access node 104.

FIG. 5B shows a flow chart of an example method 500B for wireless communication that involves downlink transmission power. At block 502B, a user device 102 may receive a DCI or a MAC CE from a wireless access node 104. At block 504B, the user device 102 may determine a plurality of downlink transmission powers indicated by the DCI or the MAC CE. Each of the plurality of transmission powers may correspond to a respective one of a plurality of time units in which a downlink signal is to be transmitted by the wireless access node 104. Accordingly, for at least some embodiments, upon determining the plurality of downlink transmission powers, the user device 102 may take appropriate action in order to properly receive the downlink signal from the wireless access node 104 over the plurality of time units. For example, the user device 102 may demodulate the downlink signal, calculate a pathloss associated with the downlink signal, and/or scale measurement results of measurements for the downlink signal according to the downlink transmission powers. In addition, for at least some embodiments, at block 504B, the user device 102 may receive the downlink signal from the wireless access node 104, where the downlink signal is transmitted by the wireless access node 104 according to the downlink transmission powers indicated in the DCI or MAC CE.

In further detail, in various embodiments, including those corresponding to FIGS. 5A and/or 5B, the wireless access node 104 may configure a DCI format for a user device 102. In addition, the wireless access node 104 may transmit a DCI with the configured DCI format to the user device 102. In addition or alternatively, the wireless access node 104 may transmit a medium access control (MAC) control element (CE) to a user device 102. The DCI or the MAC CE may indicate transmission powers for transmission of a downlink signal in a plurality of time units based on a DCI format of the DCI or the MAC CE. Additionally, in various embodiments, the wireless access node 104 may configure a plurality of transmission power candidates for a DL signal. The DCI or MAC CE may further indicate the transmission power of the DL signal from the plurality of transmission power candidates for a plurality of time units. For at least some of these embodiments, one of the plurality of transmission power candidates may be indicated as a default transmission power. If the DL signal transmission power on a time unit is not indicated by the DCI or MAC CE, the transmission power of the DL signal is the default transmission power.

In addition or alternatively, the DCI or MAC CE may include a plurality of information blocks. For at least some of these embodiments, each information block may have the same length, i.e., the number of information bits. Also, each of the plurality of information blocks may correspond to a respective one of the plurality of time units, and may indicate a transmission power of the DL signal for the corresponding time unit. For example, a first information block may indicate a transmission power of the DL signal in a first time unit of the plurality of time units; a second information block may indicate a transmission power of the DL signal in a second time unit of the plurality of the time units, and so on.

Also, for at least some embodiments, a time interval (or time offset) between the first time unit of the plurality of time units and the DCI, or the MAC CE, or the PUCCH corresponding to the MAC CE may be configured by the network in terms of symbol, sub-slot, slot, sub-frame or frame. The duration of the time unit may be configured by the wireless access node 104.

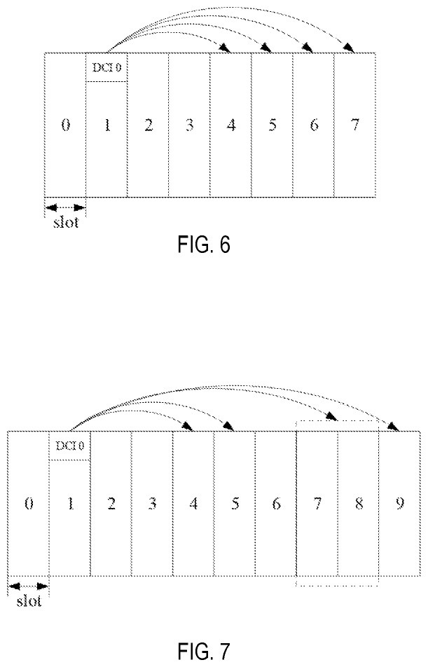

FIG. 6 is a diagram illustrating an example DL signal transmission power indication for a plurality of slots. Corresponding to FIG. 6, the wireless access node 104 may configures 4 transmission power candidates for a downlink signal (e.g., a CSI-RS) resource, including 10 dBm, 13 dBm, 16 dBm, and 18 dBm. The wireless access node 104 may further configure a default transmission power of 13 dBm. Also, the wireless access node 104 may configure the time unit of the transmission power indication to be a slot. In the example in FIG. 6, the wireless access node 104 may configure the DCI to indicate transmission power values for the downlink signal resource on 4 time units (e.g., 4 slots). Correspondingly, the DCI may include 4 information blocks, with each information block indicating a transmission power for the CSI-RS resource on a corresponding one of four slots.

Still referring to FIG. 6, the DCI may have an associated length, and each information block may also have an associated length. For example, a length of the DCI may be 8 bits, and each information block includes 2 bits. In addition or alternatively, the wireless access node 104 may configure a time offset between the DCI and a first or initial slot of the plurality of slots. For example, the DCI in FIG. 6 may indicate a time offset of 3 slots between the DCI and the first slot. Additionally, in various embodiments, the DCI indicates the time offset. As illustrated in FIG. 6, the DCI is transmitted on Slot 1, and the first slot of the plurality of slots indicated by the DCI is Slot 4. Additionally, the DCI indicates the transmission power of the downlink signal on Slot 4, Slot 5, Slot 6, and Slot 7. Correspondingly, the first information block indicates the transmission power of the downlink signal on Slot 4, the second information block indicates the transmission power of the downlink signal on Slot 5, the third information block indicates the transmission power of the downlink signal on Slot 6, and the fourth (last) information block indicates the transmission power of the downlink signal on Slot 7. Additionally, each information block may include a bit value, such as a two-bit value, that indicates a transmission power value for a corresponding slot. For example, the bit value ‘00’ may indicate a transmission power of 10 dBm, a bit value ‘01’ may indicate a transmission power of 13 dBm, the bit value ‘10’ may indicate a transmission power of 16 dBm, and a bit value ‘11’ may indicate a transmission power of 18 dBm.

In addition or alternatively, in some embodiments, the plurality of time units or the duration of the time units is also indicated by the DCI or the MAC CE. In addition to the plurality of information blocks, the DCI or the MAC CE may include a second part that indicates at least one of the start of the plurality of time units and the duration of the time unit. The start of the plurality of time units or the duration of the time unit is indicated from a plurality of candidate values configured by the wireless access node 104 or specified by the protocol.

Still referring to FIG. 6, the DCI may include an additional part that includes two fields. A first field may indicates a start of the plurality of slots in terms of a time offset between the DCI and the first slot of the plurality of slots. The candidate values configured by the wireless access node 104 may include 1, 2, 3, 4, 5, 6, 7, and 8 slots. In addition or alternatively, the first field includes a bit value that indicates a time offset. For example, a three-bit value ‘010’ may indicate a time offset value of 3 between the DCI and the first slot of the plurality of slots. In turn, the first slot of the plurality of slot indicated by the DCI is Slot 4.

Further, for at least some embodiments, the second field of the two fields may indicate a duration of the time unit. For example, candidate values configured by the wireless access node 104 may include 1, 2, 3, and 4 slots. In addition or alternatively, the second field may include a value, such as a bit value, that indicates a duration of the time unit. For example, a two-bit value ‘00’ may indicate that a duration of the time unit for transmission of the downlink signal is 1 slot.

In addition or alternatively, in various embodiments, each information block of the plurality of information blocks of a DCI or a MAC CE may indicate a specific time unit as well as a transmission power of the DL signal in the specific time unit. A given information block may indicate at least of the start of the specific time unit and the duration of the specific time unit, which may be indicated from a plurality of candidate values configured by the wireless access node 104 or specified by the protocol.

FIG. 7 is a diagram illustrating another example DL signal transmission power indication. With reference to FIG. 7, in various embodiments, the wireless access node 104 may configure a DCI to include a plurality of information blocks (e.g., 4 information blocks as shown in FIG. 7). Each information block may include three fields. A first field and a second field of the three fields may indicate a specific time unit. Also, the first field may indicate a start of the specific time unit, and the second field may indicate a duration of the specific time unit.

In further detail, the first field may include a bit value, such as a three-bit value, to indicate the start of the specific time unit. The second field may include a bit value, such as a two-bit value, to indicate the duration of the specific time unit. Further, a third field may include a bit value, such as a two-bit value, to indicate the transmission power of the DL signal on the indicated time unit. To illustrate, suppose a first information block includes a first field with the bit value ‘010’ that indicates the start of the specific time unit is Slot 4; a second field with the bit value ‘00’ that indicates the duration of the time unit is 1 slot; and a third field with the bit value ‘10’ that indicates the transmission power of the downlink signal on Slot 4 is 16 dBm. As another example illustration, suppose a second information block includes a first field with a bit value ‘011’ that indicates the start of the specific time unit is Slot 5; a second field with bit value ‘00’ that indicates the duration of the time unit is 1 slot, and a third field with bit value ‘10’ that indicates the transmission power of downlink signal on Slot 5 is 16 dBm. As a third example, a third information block may include a first field with a bit value ‘101’ that indicates the start of the specific time unit is Slot 7, a second field with a bit value ‘01’ that indicates the duration of the time unit is 2 slots, and a third field with bit value ‘00’ that indicates the transmission power of the downlink signal on Slot 7 and Slot 8 is 10 dBm. As a fourth example, a fourth information block includes a first field with a bit value ‘111’ that indicates the start of the specific time unit is Slot 9, a second field with bit value ‘00’ that indicates the duration of the time unit is 1 slot, and a third field with a bit value ‘11’ that indicates the transmission power of the downlink signal on Slot 9 is 18 dBm. Also, for some embodiments of the example in FIG. 7, the DCI does not indicate the transmission power of the downlink signal on Slot 6. In turn, the transmission power of the CSI-RS on Slot 6 is a default value, e.g., 13 dBm.

Additionally, for at least some embodiments, the start of the specific time unit is indicated in terms of the time offset between this specific time unit and the previous specific time unit, if any. For example, a second information block in a DCI or a MAC CE may have a bit value (e.g., a three-bit value), that indicates a time offset between the time unit indicated by the second information block and the time unit indicated by the first information block. For example, a three-bit value ‘000’ may indicate a time offset of 1. Correspondingly, the start of the specific time unit indicated by the second information block is slot 5. In addition or alternatively, the information block other than the first one may not include the first field. For such embodiments, the start of the time unit indicated by an information block is the one next to the previous time unit indicated by the previous information block.

Additionally, in some embodiments, the DCI format of a DCI or the MAC CE may indicate the DL transmission bandwidth for a signal transmitted on an indicated time unit or the resource type of the indicated time unit. At least one communication node, such as a wireless access node 104 and/or a user device 102, may determine one or more downlink transmission powers based on the DL transmission bandwidth and/or the resource type of the indicated time unit.

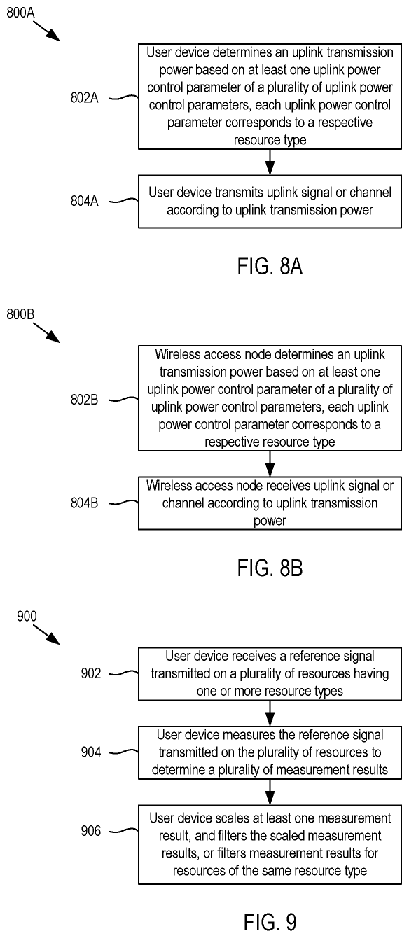

FIG. 8A is a flow chart of an example method 800 of wireless communication that involves uplink transmission power. At block 802A, a user device determines an uplink transmission power based on at least one uplink power control parameter of a plurality of uplink power control parameters. Additionally, each of the plurality of uplink power control parameters corresponds to a respective one of a plurality of resource types. Also, for at least some embodiments, the plurality of uplink power control parameters may include at least one of: a receiving power target, a maximum output power, a cell-specific power component, a UE-specific power component, a coefficient of a pathloss, a pathloss reference signal, a loop index, a power control adjustment, a plurality of transmission power command values, or a function of a bits per resource element (BPRE). At block 804A, the user device may transmit an uplink signal or an uplink channel to a wireless access node 104 according to the uplink transmission power.

FIG. 8B is a flow chart of an example method 800B of wireless communication that involves uplink transmission power. At block 802B, a wireless access node 104 determines an uplink transmission power based on at least one uplink power control parameter of a plurality of uplink power control parameters. Additionally, each of the plurality of uplink power control parameters corresponds to a respective one of a plurality of resource types. Also, for at least some embodiments, the plurality of uplink power control parameters may include at least one of: a receiving power target, a maximum output power, a cell-specific power component, a UE-specific power component, a coefficient of a pathloss, a pathloss reference signal, a loop index, a power control adjustment, a plurality of transmission power command values, or a function of a bits per resource element (BPRE). At block 804B, the wireless access node 104 may receive an uplink signal or an uplink channel from a user device 102 according to the uplink transmission power.

Other embodiments are possible including those the combine two or more of the blocks from methods 800A and 800B.

In further detail, for some embodiments, including some corresponding to FIGS. 8A and/or 8B, the wireless access node 104 may configure a plurality of power control parameters for transmission of an uplink signal or an uplink channel by a user device 102. An example uplink signal may include a sounding reference signal (SRS). Example uplink channels may include a PUCCH, a PUSCH, or a physical random access channel (PRACH).

In addition, in various embodiments, one of the plurality of power control parameters may be used for determining the transmission power of the UL signal or channel transmitted on a resource having an UL resource type, such as the first UL resource type, the second UL resource type, or the third UL resource type, as previously described. Correspondingly, for at least some embodiments, a first power control parameter may be used to determine the transmission power of the UL signal or channel transmitted on a resource having the first UL resource, type, and a second power control parameter may be used to determine the transmission power of the UL signal or channel transmitted on a resource having the second UL resource type, and a third power control parameter may be used to determine the transmission power of the UL signal or channel transmitted on a resource having the third UL resource type. In addition, for at least some embodiments, a user device 102 that is to transmit an uplink signal or channel on a resource may determine an UL resource type for the resource, and in turn, determine an uplink transmission power for the uplink transmission.

For example, using the diagram in FIG. 3, the wireless access node 104 may configure at least one first power control parameter to include a UE-specific power component value Z1, and a loop index value I1. The values Z1 and I1 may be used to determine the transmission power of the UL signal transmitted a resource having the first type of UL resource type, such as Slot 8 or Slot 9. In addition, the wireless access node 104 may configure at least one second power control parameter to include a UE-specific power component value Z2, and a loop index value I2. The values Z2 and I2 may be used to determine the transmission power of the UL signal transmitted on a resource having the second UL resource type, such as Slot 6 or Slot 7. In addition, the wireless access node 104 may configure at least one third power control parameter to include a UE-specific power component value Z3, and a loop index value I3. The values Z3 and I3 may be used to determine the transmission power of the UL signal transmitted on a resource having the third UL resource type, such as Slot 1, Slot 2 or Slot 3.

Additionally, at least one communication node, such as a wireless access node 104 and/or a user device 102, may use the one of the plurality of power control parameters to determine the transmission power of the UL signal or channel transmitted on a multiple resources having multiple UL resource types. For example, a first power control parameter may include a plurality of transmission power command values used for determining the transmission power of the UL signal transmitted on a first resource having the first UL resource type, a second resource type having the second UL resource type, and a third resource having the third UL resource type. The DCI may further indicate a transmission power command value from the plurality of transmission power command values for the UL signal or channel transmitted on a first resource having the first UL resource type, a second resource having the second UL resource type, and a third resource having the third UL resource type.

Additionally, some embodiments may utilize an accumulative power control mechanism to determine a transmission power for an UL signal or channel transmitted on a resource having a particular UL resource type, and a previous signal transmitted on a resource having the same UL resource type. For example, a user device 102 may transmit a first UL signal on Slot 1 having the third UL resource type. The previous signal used for determining the transmission power of the first UL signal is the latest signal before the first UL signal that is transmitted on Slot 1, Slot 2 or Slot 3.

Additionally, a user device 102 may transmit an UL signal or channel across a first UL resource and a second UL resource. The user device 102 may determine the transmission power of the UL signal corresponding to at least one first power control parameter being different than a transmission power of the UL signal corresponding to at least one second power control parameters. In various embodiments, a user device 102 may determine a difference, or just determine that a difference exists, between transmission powers, and correspondingly, may determine to transmit the UL signal or channel according to the larger transmission power or the smaller transmission power based on the difference and/or the determination that the difference exists. In other embodiments, if the user device 102 determines a non-zero difference, the user device 102 may determine not to transmit the UL signal or channel.

Additionally, in some embodiments, for two UL signals or channels (e.g., a first UL signal or channel and a second UL signal or channel) transmitted on a same time unit or consecutive time units, if the difference between the transmission power of the first UL signal or channel and the second signal or channel is larger than or equal to a threshold, the user device 102 may not transmit one of the two UL signals or channels. In various embodiments, the threshold may be configured by the wireless access node 104 or specified by a wireless communications protocol.

In addition, for demodulation reference signal (DMRS) bundling, the wireless access node 104 and/or the user deice 102 may determine or consider a boundary of the resource types as an event that violates power consistency and phase continuity. For example, the starting boundary of Slot 6 or Slot 8 may be considered an event that violates power consistency and phase continuity.

FIG. 9 shows a flow chart 900 of an example method for wireless communication that involves measurement results for reference signals. At block 902, a user device 102 may receive a reference signal (e.g., a CSI-RS) transmitted on a plurality of resources (e.g., a plurality of time units) having one or more resource types. At block 904, the user device 102 may measure the reference signal on the plurality of resources to determine a plurality of measurement results. At block 906, the user device 102 may scale at least one of the measurement results to determine a scaled plurality of measurement results, and filter (e.g., by averaging) the plurality of measurement results that includes the scaled measurement results and the unscaled measurement results. Alternatively, at block 906, the user device 102 may filter (e.g., by averaging) measurement results corresponding to resources having the same resource type.

In further detail, in some embodiments, including some embodiments for the method 900, the wireless access node 104 may configure a plurality of reference signals for a user device 102 to perform measurement. The reference signal may be transmitted on a plurality of resource occasions. In response, the user device 102 may measure the reference signal in the plurality of resource occasions. In addition, the user device 102 may filter (or average) the measurement results of the measurements for the plurality of resource occasions. If the reference signal in the two resource occasions has different transmission powers, then the user device 102 may scale at least one of the measurement results according to the transmission power offset.

To illustrate, with reference to FIG. 3, suppose a wireless access node 104 is to transmit a reference signal (e.g., CSI-RS) on Slot 0 and Slot 5. Further, suppose the transmission power in Slot 0 is P1 W or P1 dBm, and the transmission power in Slot 5 is P2 W or P2 dBm. The user device 102 may measure the CSI-RS in Slot 1, and determine a first measurement result to be S1, and may measure the CSI-RS in Slot 5, and determine a second measurement result to be S2.

In addition, the user device 102 may perform scaling on the first measurement result S1 and/or the second measurement result S2, such as according to an algorithm or mathematical formula. For example, after scaling, the user device 102 may determine a scaled first measurement result for the CSI-RS in Slot 0 to be S1*(P2/P1) or S1+10*log 10(P2/P1). Then, the user device 102 may filter (by averaging) the scaled first measurement result and the second measurement result. Alternatively, the user device may determine a scaled second measurement result for the CSI-RS in Slot 5 to be S2*(P1/P2) or S2+10*log 10(P1/P2). Then, the user device 102 may filter (by averaging) the scaled second measurement result and the first measurement result.

Also, in some embodiments, the wireless access node 104 may configure a set of CSI-RS resources. Further, the wireless access node 104 may configure a plurality of CSI reports corresponding to the set of CSI-RS resources. The wireless access node 104 may configure that a CSI report is associated with a resource type. For example, a first CSI report is associated with a first DL resource type, a second CSI report is associated with a second DL resource, and a third CSI report is associated with a third DL resource type.

For a CSI report, a user device 102, may determine, obtain, or calculate the CSI based on the measurement results of the CSI-RS transmitted on the resources having the one or more corresponding resource types. For example, the user device 102 may determine the CSI for the first CSI report based on the measurement results of the CSI-RS transmitted on a first resource having the first DL resource type (e.g., Slot 0 in FIG. 3), and/or may determine the CSI for the second CSI report based on the measurement results of the CSI-RS transmitted on a second resource having the second DL resource type (e.g., Slots 1, 2, or 3 in FIG. 3).

In addition or alternatively, the user device 102 may filter (e.g., by averaging) together the measurement results on the CSI-RS transmitted on resources having the same resource type. That is, the user device 102 may filter measurement results of the CSI-RS transmitted on resources each having the first DL resource type (e.g., Slot 0); may filter measurement results of the CSI-RS transmitted on resources each having the second DL resource type (e.g., Slot 1, Slot 2, and/or Slot 3); and may filter measurement results of the CSI-RS transmitted on resources each having the third DL resource type (e.g., Slot 6 or Slot 7).

Also, in various embodiments, for a CSI report, the wireless access node 104 may configure a plurality of sub-bands. Within the plurality of sub-bands, the user device 102 may report only the CSI for the sub-bands within the corresponding DL resource type. For at least some of these embodiments, for a first CSI report, the user device 102 may report the CSI for all of the sub-bands; for a second CSI report, the user device 102 may report the CSI for the sub-bands within resources having the second DL resource type; and for the third CSI report, the user device 102 may report the CSI for the sub-bands within resources having the third DL resource type.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: determining, with a wireless access node, a downlink transmission power based on at least one downlink power control parameter of a plurality of downlink power control parameters, wherein each of the plurality of downlink power control parameters corresponds to a respective one of a plurality of resource types; and transmitting, with the wireless access node, a downlink signal or a downlink channel to a user device according to the downlink transmission power.

A second aspect includes a method for wireless communication that includes: determining, with a user device, a downlink transmission power based on at least one downlink power control parameter of a plurality of downlink power control parameters, wherein each of the plurality of downlink power control parameters corresponds to a respective one of a plurality of resource types; and receiving, with the user device, a downlink signal or a downlink channel from a wireless access node, the downlink signal or the downlink channel transmitted according to the downlink transmission power.

A third aspect includes any of the first or second aspects, and further includes: configuring, with the wireless access node, the plurality of downlink power parameters to indicate the downlink transmission power.

A fourth aspect includes any of the first through third aspects, and further includes: determining, with at least one of the wireless access node or the user device, a resource on which the downlink signal is to be transmitted; determining, with at least one of the wireless access node or the user device, a resource type of the plurality of resource types for the resource on which the downlink signal is to be transmitted; and determining, with at least one of the wireless access node or the user device, the at least one downlink power control parameter based on the determined resource type.

A fifth aspect includes any of the first through fourth aspects, and further includes wherein the at least one downlink power control parameter comprises a power value for the downlink transmission power.

A sixth aspect includes any of the first through fifth aspects, and further includes wherein the at least one downlink power control parameter comprises a power offset value relative to a power value.

A seventh aspect includes any of the first through sixth aspects, and further includes wherein the at least one downlink power control parameter comprises a transmission bandwidth for transmission of the downlink signal.

An eighth aspect includes any of the first through seventh aspects, and further includes wherein the downlink signal comprising a synchronization signal/physical broadcast channel block (SSB), a channel state information reference signal (CSI-RS), a remote interference management reference signal (RIM-RS), or a positioning reference signal (PRS), and wherein the downlink channel comprises a physical downlink shared channel (PDSCH), physical broadcast channel (PBCH) or a physical downlink control channel (PDCCH).

A ninth aspect includes any of the first through eighth aspects, and further includes wherein the plurality of resource types comprises: a first resource type for a first time unit configured as a downlink time unit, wherein all frequency resources in a bandwidth part for, in, or corresponding to the first time unit are used for downlink transmissions, or for a first frequency resource for, in, or corresponding to the first time unit; a second resource type for a second time unit configured as a downlink time unit, wherein a bandwidth part for, in, or corresponding to the second time unit comprises a first part used for downlink transmissions and a second part used for uplink transmissions, or for a second frequency resource for, in, or corresponding to the second time unit; and a third resource type for a third time unit configured as an uplink time unit, wherein a bandwidth part for, in, or corresponding to the third time unit comprises a first part used for uplink transmissions and a second part used for downlink transmissions, or for a third frequency resource for, in, or corresponding to the third time unit.

A tenth aspect includes the ninth aspect, and further includes wherein the first time unit, the second time unit, and the third time unit each comprises a frame, a sub-frame, a slot, a sub-slot, or a symbol.

An eleventh aspect includes a method for wireless communication that includes: generating, with a wireless access node, a downlink control information (DCI) or a medium access control (MAC) control element (CE) to indicate a plurality of downlink transmission powers for transmission of a downlink signal or a downlink channel, wherein each of the plurality of downlink transmission powers corresponds to a respective one of a plurality of time units in which the downlink signal or the downlink channel is to be transmitted; and transmitting, with the wireless access node, the DCI or the MAC CE to a user device.

A twelfth aspect includes the eleventh aspect, and further includes: transmitting, with the wireless access node, the downlink signal or the downlink channel according to the plurality of downlink transmission powers.

A thirteenth aspect includes any of the eleventh or twelfth aspects, and further includes wherein generating the DCI or the MAC CE comprises configuring the DCI or the MAC CE to include a plurality information blocks, wherein each information block indicates a respective one of the plurality of downlink transmission powers for a respective one of the plurality of time units.

A fourteenth aspect includes the thirteenth aspect, and further includes wherein each information block further indicates the respective one of the plurality of time units, the method further comprising: determining, with the wireless access node, the plurality of time units from the plurality of information blocks.

A fifteenth aspect includes any of the eleventh through fourteenth aspects, and further includes wherein generating the DCI or the MAC CE comprises configuring the DCI or the MAC CE to indicate a starting time unit of the plurality of time units.

A sixteenth aspect includes any of the eleventh through fifteenth aspects, and further includes wherein the DCI or the MAC CE indicates a transmission bandwidth for a time unit of the plurality of time units, wherein the transmission bandwidth determines a downlink transmission power for the time unit.

A seventeenth aspect includes a method for wireless communication that includes: receiving, with a user device, a downlink control information (DCI) or a medium access control (MAC) control element (CE); and determining, with the user device, a plurality of downlink transmission powers for transmission of a downlink signal or a downlink channel from the DCI or the MAC CE, wherein each of the plurality of downlink transmission powers corresponds to a respective one of a plurality of time units in which the downlink signal or the downlink channel is transmitted.

An eighteenth aspect includes the seventeenth aspect, and further includes: receiving, with the user device, the downlink channel or the downlink signal from the wireless access node according to the plurality of transmission powers indicated by the DCI or the MAC CE.

A nineteenth aspect includes any of the seventeenth or eighteenth aspects, and further includes wherein the DCI or the MAC CE comprises a plurality information blocks, wherein each information block indicates a respective one of the plurality of downlink transmission powers for a respective one of the plurality of time units, and wherein determining the plurality of downlink transmission powers from the DCI or the MAC CE comprises determining the plurality of transmission powers from the plurality of information blocks.

A twentieth aspect includes the nineteenth aspect, and further includes wherein each information block further indicates the respective one of the plurality of time units, the method further comprising: determining, with the user device, the plurality of time units from the plurality of information blocks.

A twenty-first aspect includes any of the seventeenth through twentieth aspects, and further includes wherein the DCI or the MAC CE indicates a starting time unit of the plurality of time units, the method further comprising: determining, with the user device, the starting time unit from the DCI or the MAC CE; and determining, with the user device, the plurality of time units based on the starting time unit.

A twenty-second aspect includes any of the seventeenth through twenty-first aspects, and further includes wherein the DCI or the MAC CE indicates a transmission bandwidth for a time unit of the plurality of time units, wherein determining the plurality of downlink transmission powers from the DCI or the MAC CE comprises determining a downlink transmission power for the time unit based on the transmission bandwidth indicated in the DCI or the MAC CE.

A twenty-third aspect includes a method for wireless communication that includes: determining, with a user device, an uplink transmission power based on at least one uplink power control parameter of a plurality of uplink power control parameters, wherein each of the plurality of uplink power control parameters corresponds to a respective one of a plurality of resource types; and transmitting, with the user device, an uplink signal or an uplink channel to a wireless access node according to the uplink transmission power.

A twenty-fourth aspect includes a method for wireless communication that includes: determining, with a wireless access node, an uplink transmission power based on at least one uplink power control parameter of a plurality of uplink power control parameters, wherein each of the plurality of uplink power control parameters corresponds to a respective one of a plurality of resource types; and receiving, with the wireless access node, an uplink signal or an uplink channel from a user device, the uplink signal or uplink channel transmitted according to the uplink transmission power.

A twenty-fifth aspect includes any of the twenty-third or twenty-fourth aspects, and further includes wherein at least one of the plurality of uplink power control parameters comprises a receiving power target, a maximum output power, a cell-specific power component, a user equipment (UE)-specific power component, a coefficient of a pathloss, a pathloss reference signal, a loop index, a power control adjustment state, a plurality of transmission power command values, or a function of a bits per resource element (BPRE).

A twenty-sixth aspect includes any of the twenty-third through twenty-fifth aspects, and further includes wherein the plurality of resource types comprises: a first resource type for a first time unit configured as an uplink time unit, wherein all frequency resources in a bandwidth part for, in, or corresponding to the first time unit are used for uplink transmissions, or for a first frequency resource for, in, or corresponding to the first time unit; a second resource type for a second time unit configured as an uplink time unit, wherein a bandwidth part for, in, or corresponding to the second time unit comprises a first part used for uplink transmissions and a second part used for downlink transmissions, or for a second frequency resource for, in, or corresponding to the second time unit; and a third resource type for a third time unit configured as a downlink time unit, wherein a bandwidth part for, in, or corresponding to the third time unit comprises a first part used for downlink transmissions and a second part used for uplink transmissions, or for a third frequency resource for, in, or corresponding to the third time unit.

A twenty-seventh aspect any of the twenty-third through twenty-sixth aspects, and further includes wherein the uplink signal or the uplink channel is transmitted on a first resource having a first resource type of the plurality of resource types and a second resource having a second resource type of the plurality of resource types, wherein determining the uplink transmission power comprises: determining a first uplink transmission power for transmission on the first resource based on a first uplink power control parameter of the plurality of uplink power control parameters; and determining a second uplink transmission power for transmission on the second resource based on a second uplink power control parameter of the plurality of uplink power control parameters.

A twenty-eighth aspect includes a wireless communications apparatus comprising a processor and a memory, wherein the processor is configured to read code from the memory to implement a method of any of the first through twenty-seventh aspects.

A twenty-ninth aspect includes a computer program product comprising a computer-readable program medium comprising code stored thereupon, the code, when executed by a processor, causing the processor to implement a method of any of the first through twenty-seventh aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, with a wireless access node, a downlink transmission power based on at least one downlink power control parameter of a plurality of downlink power control parameters, wherein each of the plurality of downlink power control parameters corresponds to a respective one of a plurality of resource types; and
transmitting, with the wireless access node, a downlink signal or a downlink channel to a user device according to the downlink transmission power.

2. A method for wireless communication, the method comprising:
determining, with a user device, a downlink transmission power based on at least one downlink power control parameter of a plurality of downlink power control parameters, wherein each of the plurality of downlink power control parameters corresponds to a respective one of a plurality of resource types; and
receiving, with the user device, a downlink signal or a downlink channel from a wireless access node, the downlink signal or the downlink channel transmitted according to the downlink transmission power.

3. The method of claim 1, further comprising:
configuring, with the wireless access node, the plurality of downlink power control parameters to indicate the downlink transmission power.

4. The method of claim 1, further comprising:
determining, with at least one of the wireless access node or the user device, a resource on which the downlink signal is to be transmitted;
determining, with at least one of the wireless access node or the user device, a resource type of the plurality of resource types for the resource on which the downlink signal is to be transmitted; and
determining, with at least one of the wireless access node or the user device, the at least one downlink power control parameter based on the determined resource type.

5. The method of claim 1, wherein the at least one downlink power control parameter comprises a power value for the downlink transmission power.

6. The method of claim 1, wherein the at least one downlink power control parameter comprises a power offset value relative to a power value.

7. The method of claim 1, wherein the at least one downlink power control parameter comprises a transmission bandwidth for transmission of the downlink signal.

8. The method of claim 1, wherein the downlink signal comprising a synchronization signal/physical broadcast channel block (SSB), a channel state information reference signal (CSI-RS), a remote interference management reference signal (RIM-RS), or a positioning reference signal (PRS), and wherein the downlink channel comprises a physical downlink shared channel (PDSCH), a physical broadcast channel (PBCH) or a physical downlink control channel (PDCCH).

9. The method of claim 1, wherein the plurality of resource types comprises:
a first resource type for a first time unit configured as a downlink time unit, wherein all frequency resources in a bandwidth part for, in, or corresponding to the first time unit are used for downlink transmissions, or for a first frequency resource for, in, or corresponding to the first time unit;
a second resource type for a second time unit configured as a downlink time unit, wherein a bandwidth part for, in, or corresponding to the second time unit comprises a first part used for downlink transmissions and a second part used for uplink transmissions, or for a second frequency resource for, in, or corresponding to the second time unit; and
a third resource type for a third time unit configured as an uplink time unit, wherein a bandwidth part for, in, or corresponding to the third time unit comprises a first part used for uplink transmissions and a second part used for downlink transmissions, or for a third frequency resource for, in, or corresponding to the third time unit.

10. The method of claim 9, wherein the first time unit, the second time unit, and the third time unit each comprises a frame, a sub-frame, a slot, a sub-slot, or a symbol.

11. A method for wireless communication, the method comprising:
generating, with a wireless access node, a downlink control information (DCI) or a medium access control (MAC) control element (CE) to indicate a plurality of downlink transmission powers for transmission of a downlink signal or a downlink channel, wherein each of the plurality of downlink transmission powers corresponds to a respective one of a plurality of time units in which the downlink signal or the downlink channel is to be transmitted; and
transmitting, with the wireless access node, the DCI or the MAC CE to a user device.

12. The method of claim 11, further comprising:
transmitting, with the wireless access node, the downlink signal or the downlink channel according to the plurality of downlink transmission powers.

13. The method of claim 11, wherein generating the DCI or the MAC CE comprises configuring the DCI or the MAC CE to include a plurality information blocks, wherein each information block indicates a respective one of the plurality of downlink transmission powers for a respective one of the plurality of time units.

14. The method of claim 13, wherein each information block further indicates the respective one of the plurality of time units, the method further comprising:
determining, with the wireless access node, the plurality of time units from the plurality of information blocks.

15. The method of claim 11, wherein generating the DCI or the MAC CE comprises configuring the DCI or the MAC CE to indicate a starting time unit of the plurality of time units.

16. The method of claim 11, wherein the DCI or the MAC CE indicates a transmission bandwidth for a time unit of the plurality of time units, wherein the transmission bandwidth determines a downlink transmission power for the time unit.
